(19) United States
(12) Patent Application Publication
(10) Pub. No.: US 2025/0309253 A1
(43) Pub. Date: Oct. 2, 2025

(54) POSITIVE ELECTRODE ACTIVE MATERIAL FOR LITHIUM-ION SECONDARY BATTERY, METHOD FOR PRODUCING THE SAME, AND LITHIUM-ION SECONDARY BATTERY USING THE SAME

(71) Applicants: HONDA MOTOR CO., LTD., Tokyo (JP); NATIONAL INSTITUTE OF ADVANCED INDUSTRIAL SCIENCE AND TECHNOLOGY, Tokyo (JP)

(72) Inventors: Kazumasa SAKATSUME, Saitama (JP); Takashi HAKARI, Saitama (JP); Kazuki CHIBA, Saitama (JP); Akihisa TANAKA, Saitama (JP); Yoshiyuki MORITA, Saitama (JP); Junji AKIMOTO, Ibaraki (JP); Kunimitsu KATAOKA, Ibaraki (JP); Hideaki NAGAI, Ibaraki (JP)

(21) Appl. No.: 19/087,609

(22) Filed: Mar. 24, 2025

(30) Foreign Application Priority Data
Mar. 30, 2024 (JP) 2024-058342

(51) Int. Cl. H01M 4/505; C01G 45/1228; H01M 4/02; H01M 10/0525

(52) U.S. Cl. CPC H01M 4/505; C01G 45/1228; H01M 10/0525; C01P 2002/50; C01P 2002/54; C01P 2002/72; C01P 2002/74; C01P 2006/40; H01M 2004/028

(57) ABSTRACT

A positive electrode active material for a lithium-ion secondary battery according to one embodiment of the present invention is represented by the following formula (I):

LiₐMnₓTi_{y}A1_{z}O₂ (I)

wherein a satisfies a relationship of 0.40≤a≤0.50, and x, y, and z satisfy relationships of x+y+z=1, 0.48≤x≤0.58, 0.31≤y≤0.50, and 0.01≤z≤0.12.

This application is based on and claims the benefit of priority from Japanese Patent Application No. 2024-058342, filed on 30 Mar. 2024, the content of which is incorporated herein by reference.

### BACKGROUND OF THE INVENTION

### Field of the Invention

The present invention relates to a positive electrode active material for a lithium-ion secondary battery, a method for producing the same, and a lithium-ion secondary battery using the same.

### Related Art

In recent years, research and development have been conducted on secondary batteries that contribute to energy efficiency in order to ensure that more people have access to affordable, reliable, sustainable, and advanced energy.

As a positive electrode active material for lithium-ion secondary batteries, a LiMnTi-containing oxide that contains lithium, manganese, and titanium and has a tunnel structure has been studied (see Patent Documents 1 and 2).
Patent Document 1: Japanese Unexamined Patent Application, Publication No. 2005-263583
Patent Document 2: Japanese Unexamined Patent Application, Publication No. 2005-268127

### SUMMARY OF THE INVENTION

In the technology related to secondary batteries, improvement in electric capacity per mass is one of the problems. In particular, in a secondary battery used as a power source for driving a motor of an electric vehicle or a hybrid electric vehicle, it is important to improve the electric capacity per mass. Therefore, it is also desired to further improve the electric capacity per mass of the LiMnTi-containing oxide having a tunnel structure. In order to improve the electric capacity of the LiMnTi-containing oxide, it is conceivable to add a metal element, but from the viewpoint of resource sustainability, the metal element to be added is desired to be an element having a small atomic weight and being industrially accessible.

The present invention has been made in view of the above problems, and an object of the present invention is to provide a positive electrode active material for a lithium-ion secondary battery that can be produced using a metal element having a small atomic weight and being industrially accessible and has a high electric capacity per mass, a method for producing the same, and a lithium-ion secondary battery using the same.

The present inventors have found that it is effective to add Al to a LiMnTi-containing oxide in order to solve the above problems, and have completed the present invention.

Accordingly, the present invention provides the following.

A first aspect of the present invention relates to a positive electrode active material for a lithium-ion secondary battery represented by the following formula (I):

LiₐMnₓTi_{y}Al_{z}O₂ (I)

wherein a satisfies a relationship of 0.40≤a≤0.50, and x, y, and z satisfy relationships of x+y+z=1, 0.48≤x≤0.58, 0.31≤y≤0.50, and 0.01≤z≤0.12.

According to the positive electrode active material for a lithium-ion secondary battery of the first aspect, since Li, Mn, Ti and Al are contained in the above range, the electric capacity per mass is high. In addition, Li, Mn, Ti, and Al are industrially accessible and have high resource sustainability. In particular, Al is industrially accessible and inexpensive, and has a small atomic weight, even compared to Mn and Ti.

A second aspect of the present invention relates to the positive electrode active material for a lithium-ion secondary battery as described in the first aspect, in which x satisfies a relationship of 0.48≤x≤0.58, y satisfies a relationship of 0.37≤y≤0.50, and z satisfies a relationship of 0.01≤z≤0.06.

According to the positive electrode active material for a lithium-ion secondary battery of the second aspect, since Li, Mn, Ti and Al are contained in the above range, the electric capacity per mass is higher.

A third aspect of the present invention relates to the positive electrode active material for a lithium-ion secondary battery as described in the first or second aspect, having a tunnel structure Pbam.

According to the positive electrode active material for a lithium-ion secondary battery of the third aspect, since the positive electrode active material has the tunnel structure Pbam, the electric capacity per mass is higher.

A fourth aspect of the present invention relates to the positive electrode active material for a lithium-ion secondary battery as described in the third aspect, in which the positive electrode active material is in a single phase having the tunnel structure Pbam.

According to the positive electrode active material for a lithium-ion secondary battery of the fourth aspect, since the positive electrode active material is in a single phase of the tunnel structure Pbam, the electric capacity per mass is further increased.

A fifth aspect of the present invention relates to the positive electrode active material for a lithium-ion secondary battery as described in any one of the first to fourth aspects, in which an X-ray diffraction pattern measured using Cuka as an X-ray source has two diffraction peaks within a range of a diffraction angle 20 between 19.5 degrees and 21.0 degrees, and of the two diffraction peaks, a ratio of a maximum diffraction intensity of a diffraction peak on a high angle side to a maximum diffraction intensity of a diffraction peak on a low angle side is within a range of 1.00 or more and 1.50 or less.

According to the positive electrode active material for a lithium-ion secondary battery of the fifth aspect, since the maximum diffraction intensities of the two diffraction peaks satisfy the above relationship in a range of the diffraction angle 20 between 19.5 degrees and 21.0 degrees inclusive, the electric capacity per mass is higher.

A sixth aspect of the present invention relates to the positive electrode active material for a lithium-ion secondary battery according to any one of the first to fifth aspects, in which the content of Na is 4 mol % or less with respect to a total content of Mn, Ti, and Al.

According to the positive electrode active material for a lithium-ion secondary battery of the sixth aspect, since the content of Na is as small as the above-described amount, it is possible to suppress a decrease in electric capacity due to mixing of Na.

A seventh aspect of the present invention relates to a method for producing the positive electrode active material for a lithium-ion secondary battery as described in any one of the first to sixth aspects, the method including substituting at least a part of sodium in the NaMnTiAl-containing oxide having a tunnel structure and represented by the following general formula (II) with lithium:

Na_{b}MnₓTi_{y}Al_{z}O₂ (II)
wherein b satisfies a relationship of 0.40≤b≤0.50, and x, y, and z satisfy relationships of x+y+z=1, 0.48≤x≤0.58, 0.31≤y≤0.50, and 0.01≤z≤0.12.

According to the method for producing the positive electrode active material for a lithium-ion secondary battery of the seventh aspect, since the NaMnTiAl-containing oxide of the general formula (II) is used as a raw material, the positive electrode active material for a lithium-ion secondary battery can be produced with high efficiency.

An eighth aspect of the present invention relates to a lithium-ion secondary battery including a positive electrode mixture layer including the positive electrode active material for a lithium-ion secondary battery as described in any one of the first to sixth aspects.

According to the lithium-ion secondary battery of the eighth aspect, since the positive electrode active material for a lithium-ion secondary battery described above is included, the electric capacity per mass is high.

According to the present invention, it is possible to provide a positive electrode active material for a lithium-ion secondary battery that can be produced using a metal element being industrially accessible and having a small atomic weight, and has a high electric capacity per mass, a method for producing the same, and a lithium-ion secondary battery using the same.

### BRIEF DESCRIPTION OF THE DRAWINGS

FIG. 1 is an X-ray diffraction pattern of LiMnTiAl-containing oxide powders obtained in Examples 1 to 3 and Comparative Example 1;

FIG. 2 is an X-ray diffraction pattern of LiMnTiAl-containing oxide powders obtained in Examples 4 to 6 and Comparative Example 2;

FIG. 3 is an X-ray diffraction pattern of LiMnTiAl-containing oxide powders obtained in Comparative Examples 3 to 6;

FIG. 4 is an X-ray diffraction pattern of LiMnTiAl-containing oxide powder obtained in Example 5 and an X-ray diffraction pattern of NaMnTiAl-containing oxide powder used in the production thereof;

FIG. 5 is a graph showing an initial discharge curve of a two-electrode cell using the LiMnTiAl-containing oxide powders obtained in Examples 1 to 3 and Comparative Example 1;

FIG. 6 is a graph showing an initial discharge curve of a two-electrode cell using the LiMnTiAl-containing oxide powders obtained in Examples 4 to 6 and Comparative Example 2; and

FIG. 7 is a graph showing an initial discharge curve of a two-electrode cell using the LiMnTiAl-containing oxide powders obtained in Comparative Examples 3 to 6.

### DETAILED DESCRIPTION OF THE INVENTION

Hereinafter, embodiments of the present invention will be described. However, the following embodiments exemplify the present invention, and the present invention is not limited to the following embodiments.

The positive electrode active material for a lithium-ion secondary battery of the present embodiment is a LiMnTiAl-containing oxide containing lithium (Li), manganese (Mn), titanium (Ti), and aluminum (Al). The positive electrode active material for a lithium-ion secondary battery is represented by the following general formula (I):

LiₐMnₓTi_{y}Al_{z}O₂ (I)

wherein a satisfies a relationship of 0.40≤a≤0.50, and x, y, and z satisfy relationships of x+y+z=1, 0.48≤x≤0.58, 0.31≤y≤0.50, and 0.01≤z≤0.12.

In the general formula (I), x, y, and z more preferably satisfy relationships of 0.48≤x≤0.58, 0.37≤y≤0.50, and 0.01≤z≤0.06, more preferably satisfy relationships of 0.54≤ x≤0.58, 0.37≤y≤0.44, and 0.01≤z≤0.06, and most preferably satisfy relationships of 0.54≤x≤0.58, 0.37≤y≤0.41, and 0.04≤z≤0.06. By containing Li, Mn, Ti and Al in the above ranges, the electric capacity per mass of the LiMnTiAl-containing oxide is higher.

The LiMnTiAl-containing oxide preferably has a tunnel structure Pbam. By having the tunnel structure Pbam, the electric capacity per mass of the LiMnTiAl-containing oxide is higher. The LiMnTiAl-containing oxide is more preferably in a single phase having a tunnel structure Pbam. When the tunnel structure Pbam is in a single phase, the electric capacity per mass of the LiMnTiAl-containing oxide is further increased. The technical feature that the LiMnTiAl-containing oxide is in a single phase having the tunnel structure Pbam can be confirmed from, for example, an X-ray diffraction pattern of the LiMnTiAl-containing oxide.

The LiMnTiAl-containing oxide may have two diffraction peaks in a range of the diffraction angle 20 between 19.5 degrees and 21.0 degrees inclusive. Of the two diffraction peaks, the ratio (peak intensity ratio B/A) of the maximum diffraction intensity (B) of the diffraction peak on the high angle side to the maximum diffraction intensity (A) of the diffraction peak on the low angle side may be in the range of, for example, 1.00 or more and 1.50 or less. The peak intensity ratio B/A is more preferably in the range of 1.00 or more and 1.40 or less, more preferably in the range of 1.00 or more and 1.25 or less, and most preferably in the range of 1.10 or more and 1.25 or less. By the maximum diffraction intensities of the two diffraction peaks satisfying the above relationship within the range of the diffraction angle 20 between 19.5 degrees and 21.0 degrees inclusive, the electric capacity per mass of the LiMnTiAl-containing oxide is higher.

The positive electrode active material for a lithium-ion secondary battery of the present embodiment can be produced, for example, by a method in which at least a part of Na of the NaMnTiAl-containing oxide having a tunnel structure is substituted with Li.

As the NaMnTiAl-containing oxide, an oxide represented by the following general formula (II) can be used.

Na_{b}MnₓTi_{y}Al_{z}O₂ (II)

wherein b satisfies a relationship of 0.40≤b≤0.50, and x, y, and z satisfy relationships of x+y+z=1, 0.48≤x≤0.58, 0.31≤y≤0.50, and 0.01≤z≤0.12. The preferable ranges of x, y, and z are the same as those in the case of the LiMnTiAl-containing oxide described above.

The NaMnTiAl-containing oxide can be produced by mixing a sodium source, a manganese source, a titanium source, and an aluminum source to obtain a raw material mixture, and calcining the obtained raw material mixture. The sodium source, the manganese source and the titanium source are not particularly limited, and various compounds such as oxides, carbonates, hydroxides and chlorides can be used. The calcination conditions of the raw material mixture may be, for example, in the atmosphere at a calcination temperature of 900 to 1200° C. The calcination time period varies depending on conditions such as the composition of the raw material mixture and the calcination temperature, and is, for example, in the range of 1 to 30 hours.

As a method of substituting Na in the NaMnTiAl-containing oxide with Li, for example, a molten salt method using a molten salt of a lithium salt as the lithium source or a solution method using a lithium compound solution as the lithium source can be used.

In the molten salt method, for example, a NaMnTiAl-containing oxide and a lithium salt are mixed, the obtained mixture is heated to generate a molten salt of the lithium salt, and Na of the NaMnTiAl-containing oxide is substituted with Li in the generated molten salt of the lithium salt. Examples of the lithium salt used in the molten salt method include low melting point lithium salts such as lithium nitrate and lithium halide (lithium chloride, lithium bromide, and lithium iodide). The mixing ratio of the NaMnTiAl-containing oxide and the lithium salt is in a range of 2 to 40, and preferably in a range of 10 to 30 in terms of mole ratio (Li/Na ratio) of lithium of the lithium salt to sodium of the NaMnTiAl-containing oxide. The heating temperature in the molten salt method is equal to or higher than the melting point of the lithium salt. The heating temperature is preferably 330° C. or lower.

In the solution method, for example, a NaMnTiAl-containing oxide and a lithium compound solution are mixed, the obtained mixture solution is heated, and Na of the NaMnTiAl-containing oxide is replaced with Li in the mixture solution. As a solvent of the lithium compound solution, water or an organic solvent can be used. Examples of the organic solvent include higher alcohols such as hexanol, ethoxyethanol, etc., ethers such as diethylene glycol monoethyl ether, etc., and organic solvents having a boiling point of 140° C. or higher. Examples of the lithium compounds used in the solution method include soluble lithium compounds such as lithium carbonate, lithium acetate, lithium nitrate, lithium oxalate, lithium halide, lithium hydroxide, butyl lithium, etc. The concentration of lithium in the lithium compound solution is, for example, in the range of 3 to 10 mol %, and preferably in the range of 4 to 6 mol %. The heating temperature in the solution method is equal to or lower than the boiling point of the lithium salt solution. The heating temperature is, for example, 100° C. or higher, and preferably 140° C. or higher. The concentration of the NaMnTiAl-containing oxide in the mixed solution is, for example, in the range of 1 to 20 mass %.

The LiMnTiAl-containing oxide is produced by substituting Na in the NaMnTiAl-containing oxide with Li. The obtained LiMnTiAl-containing oxide may be washed and dried. The washing may be performed by water washing. washing the LiMnTiAl-containing oxide with water, Na substituted with Li and an unreacted lithium source are removed. The drying method is not particularly limited, and various methods used as a method for drying an inorganic substance, such as a heating drying method, a vacuum drying method, a spray drying method, etc. can be used.

In the positive electrode active material obtained as described above, a trace amount of Na may be mixed. The content of Na in the positive electrode active material is preferably 4 mol % or less with respect to the total content of Mn, Ti, and Al, for example. When the content of Na is as small as 4 mols, it is possible to suppress a decrease in electric capacity due to mixing of Na. The content of Na may be 1 mol % or more with respect to the total content of Mn, Ti, and Al.

The positive electrode active material for a lithium-ion secondary battery of the present embodiment can be used as a positive electrode active material of a lithium-ion secondary battery. A lithium-ion secondary battery includes, for example, a positive electrode, a negative electrode, an electrolytic solution, a separator disposed between the positive electrode and the negative electrode, and an exterior body that houses these. Instead of the electrolytic solution, a solid electrolyte may be used.

The positive electrode includes a positive electrode current collector and a positive electrode active material layer formed on a surface of the positive electrode current collector. The positive electrode active material layer includes the positive electrode active material for a lithium-ion secondary battery of the present embodiment. The positive electrode active material layer may contain a conductive additive and a binder. Since the positive electrode active material for a secondary battery of the present embodiment is chemically stable, the conductive aid and the binder are not particularly limited, and known materials used in positive electrode active material layers of lithium-ion secondary batteries can be used. The positive electrode current collector is not particularly limited, and known positive electrode current collectors used in lithium-ion secondary batteries, such as an aluminum foil, etc. can be used.

As the negative electrode, a laminate including a negative electrode current collector and a negative electrode active material layer formed on the surface of the negative electrode current collector can be used. The negative electrode active material layer includes a negative electrode active material. As the negative electrode active material, metallic lithium, a substance capable of occluding and releasing lithium, a metal or a metalloid forming an alloy with lithium can be used. Examples of the material capable of occluding and releasing lithium include lithium transition metal oxides such as lithium titanate, etc., transition metal oxides such as TiO₂, Nb₂O₃, WO₃, etc., Sio, metal sulfides, metal nitrides, and carbon materials such as artificial graphite, natural graphite, graphite, soft carbon, hard carbon, etc. Examples of metals or metalloids that form alloys with lithium include Mg, Si, Au, Ag, In, Ge, Sn, Pb, Al, Zn, etc. In the case where the negative electrode active material is in the form of powder, the negative electrode active material layer may contain a conductive aid and a binder. The conductive aid and the binder are not particularly limited, and known materials used in negative electrode active material layers of lithium-ion secondary batteries can be used. The negative electrode current collector is not particularly limited, and a known material used in lithium-ion secondary batteries, such as copper foil, etc., can be used.

The electrolytic solution includes an organic solvent and an electrolyte. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. Examples of the cyclic carbonates include ethylene carbonate, propylene carbonate, vinylene carbonate, fluoroethylene carbonate, etc. Examples of the chain carbonates include dimethyl carbonate, diethyl carbonate, ethyl methyl carbonate, etc. Examples of the cyclic ethers include tetrahydrofuran, 2-methyltetrahydrofuran, tetrahydropyran, 1,3-dioxolane, 4-methyl 1,3-dioxolane, etc. Examples of the chain ethers include 1,2-dimethoxyethane, 1,2-diethoxyethane, ethoxymethoxyethane, diethyl ether, etc. Examples of the hydrofluoroethers include 1, 1, 2, 2-tetrafluoroethyl-2, 2, 2-trifluoroethyl ether, 1, 1, 2, 2-tetrafluoroethyl-2, 2, 3, 3-tetrafluoropropyl ether, bis(2, 2, 2-trifluoroethyl) ether, 1, 2-bis(1, 1, 2, 2-tetrafluoroethoxy) ethane, etc. Examples of the aromatic ethers include anisole. Examples of the sulfones include sulfolane, methylsulfolane, etc. Examples of the cyclic esters include γ-butyrolactone, etc. Examples of the chain carboxylic acid esters include acetate, butyrate, propionate, etc. Examples of the nitriles include acetonitrile, propionitrile, etc. The organic solvents may be used alone or in a combination of two or more types thereof.

The electrolyte is a source of lithium ions, which are charge transfer media, and includes a lithium salt. Examples of the lithium salts include LiPF₆, LiBF₄, LiClO₄, LiASF₆, LiCF₃SO₃, LiC(CF₃SO₂)₃, LiN(CF₃SO₂)₂(LiTFSI), LiN(FSO₂)₂(LiFSI), LiBC₄O₈, etc. The lithium salt may be used alone or in a combination of two or more types thereof.

As the solid electrolyte, for example, a sulfide solid electrolyte, an oxide solid electrolyte, a nitride solid electrolyte, a halide solid electrolyte, etc. can be used. Examples of the sulfide solid electrolyte include Li₂S—P₂S₅, Li₂S—P₂S₅—LiI, etc. Examples of the oxide solid electrolyte include NASICON type oxides, garnet type oxides, perovskite type oxides, etc. Examples of the NASICON type oxides include oxides containing Li, Al, Ti, P and O (e. g., Li_{1.5}Al_{0.5}Ti_{1.5}(PO₄)₃). Examples of the garnet-type oxides include oxides containing Li, La, Zr, and O (e. g., Li₇La₃Zr₂O₁₂). Examples of the perovskite oxides include oxides containing Li, La, Ti, and O (for example, LiLaTiO₃).

The separator is not particularly limited, and for example, a porous sheet or a nonwoven fabric sheet can be used. Examples of the material of the porous sheet include polyolefins such as polyethylene, polypropylene, etc., aramid, polyimide, fluororesin, etc. Examples of the material of the nonwoven fabric sheet include glass fibers, cellulose fibers, etc.

The exterior body is not particularly limited, and a known exterior body used in lithium-ion secondary batteries, such as a metal container, a container made of a laminate film, etc., can be used.

According to the positive electrode active material for a lithium-ion secondary battery of the present embodiment having the above-described configuration, since Li, Mn, Ti, and Al are contained within the above-described ranges, the electric capacity per mass is high. In addition, Li, Mn, Ti, and Al are industrially accessible and have high resource sustainability. In particular, compared to Mn and Ti, Al is industrially accessible, inexpensive, and has a small atomic weight. Therefore, the positive electrode active material for a lithium-ion secondary battery of the present embodiment can be stably manufactured over a long period of time.

According to the method for producing a positive electrode active material for a lithium-ion secondary battery of the present embodiment, since the NaMnTiAl-containing oxide of the above general formula (II) is used as the raw material, the positive electrode active material for a secondary battery of the present embodiment can be produced with high efficiency.

According to the lithium-ion secondary battery of the present embodiment, since the positive electrode active material for a lithium-ion secondary battery of the present embodiment is included, the electric capacity per mass is high.

### EXAMPLES

### [Example 1] (Preparation of NaMnTiAl-containing Oxide Powder)

Na₂CO₃, Mn₂O₃, TiO₂ and Al(OH)₃ were weighed so that the mole ratio of Na:Mn:Ti:Al was 0.50:0.50:0.48:0.02 and the total mass was 1.0 g. The weighed Na₂CO₃, Mn₂O₃, TiO₂ and Al(OH)₃ were mixed using a mortar and pestle. The obtained raw material mixture was put in an alumina crucible and calcined in the atmosphere at a calcination temperature of 1,000° C. for a calcination time period of 12 hours. After the baking, the obtained baked product was pulverized using a mortar and a pestle. Measurement of the X-ray diffraction pattern of the obtained calcined product powder confirmed that the obtained calcined product powder was a NaMnTiAl oxide powder having a tunnel structure.

### (Preparation of LiMnTiAl-containing Oxide Powder)

1.5 g of the obtained NaMnTiAl oxide and 5.4 g of LiNO₃ were weighed and mixed using a mortar and a pestle. Next, the obtained mixture was put into a crucible and heated in the atmosphere at a heating temperature of 270° C. for a heating time of 12 hours. After heating, the treated powder (LiMnTiAl-containing oxide powder) was collected from the crucible. After the collected LiMnTiAl-containing oxide powder was washed with water, an operation of removing moisture by centrifugation was performed three times. The LiMnTiAl-containing oxide powder from which moisture had been removed was placed in a petri dish and dried under vacuum at a temperature of 100° C. for 6 hours. The dried LiMnTiAl-containing oxide powder was pulverized using a mortar and a pestle.

### Examples 2 to 5 and Comparative Examples 1 to 6

A NaMnTiAl-containing oxide powder was produced in the same manner as in Example 1 except that the mixing ratio of Na:Mn:Ti:Al in the NaMnTiAl-containing oxide powder was set to the mole ratio shown in Table 1 below, in the preparation of the NaMnTiAl-containing oxide powder. Next, using the obtained NaMnTiAl oxide, LiMnTiAl-containing oxide powder was obtained in the same manner as in Example 1.

TABLE 1

Raw material blending ratio (mole ratio)

| | Na | Mn | Ti | Al |
|---|---|---|---|---|
| Example 1 | 0.50 | 0.50 | 0.48 | 0.02 |
| Example 2 | 0.50 | 0.50 | 0.45 | 0.05 |
| Comparative | 0.50 | 0.50 | 0.50 | Not added |
| Example 1 | | | | |
| Example 3 | 0.50 | 0.56 | 0.42 | 0.02 |
| Example 4 | 0.50 | 0.56 | 0.39 | 0.05 |
| Example 5 | 0.50 | 0.56 | 0.33 | 0.11 |
| Comparative | 0.50 | 0.56 | 0.44 | Not added |
| Example 2 | | | | |
| Comparative | 0.50 | 0.67 | 0.31 | 0.02 |
| Example 3 | | | | |
| Comparative | 0.50 | 0.67 | 0.28 | 0.05 |
| Example 4 | | | | |
| Comparative | 0.50 | 0.67 | 0.22 | 0.11 |
| Example 5 | | | | |
| Comparative | 0.50 | 0.67 | 0.33 | Not added |
| Example 6 | | | | |

### Evaluation

Regarding the LiMnTiAl-containing oxide powders obtained in Examples 1 to 5 and Comparative Examples 1 to 6, the chemical composition, the X-ray diffraction pattern, and the charge-discharge characteristics were evaluated by the following methods.

### (Chemical Compositions)

Each sample was dissolved with acid. The contents of Li, Na, Mn, Ti and Al in the obtained solution were measured using an ICP emission spectrometer. The contents of Li, Na, Mn, Ti, and Al thus obtained were converted into mole amounts, assuming that the total amount of Mn, Ti, and Al was 1 mol. The compositional formula was calculated from the mole amounts of Li, Mn, Ti, and Al obtained. The results are shown in Table 2 below.

### (X-Ray Diffraction Pattern)

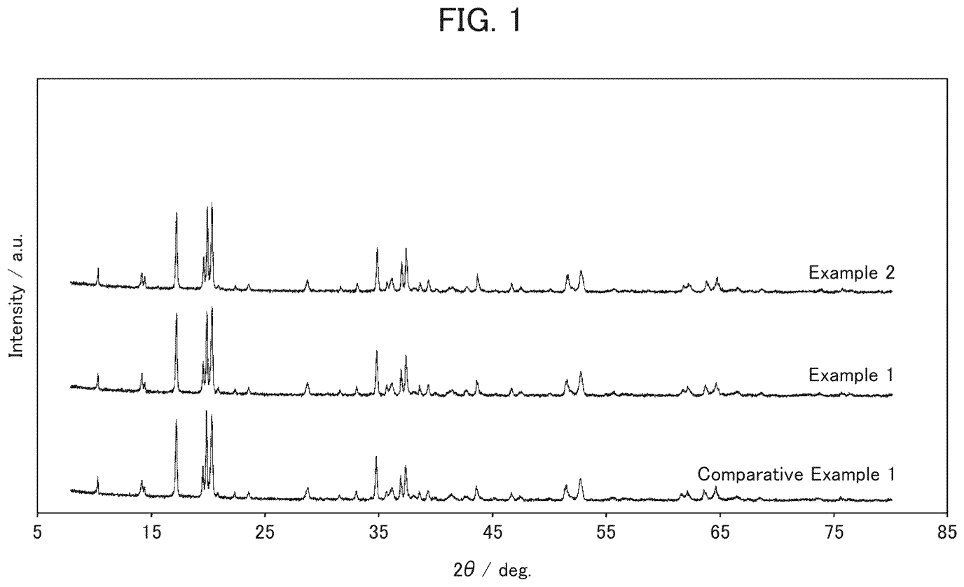

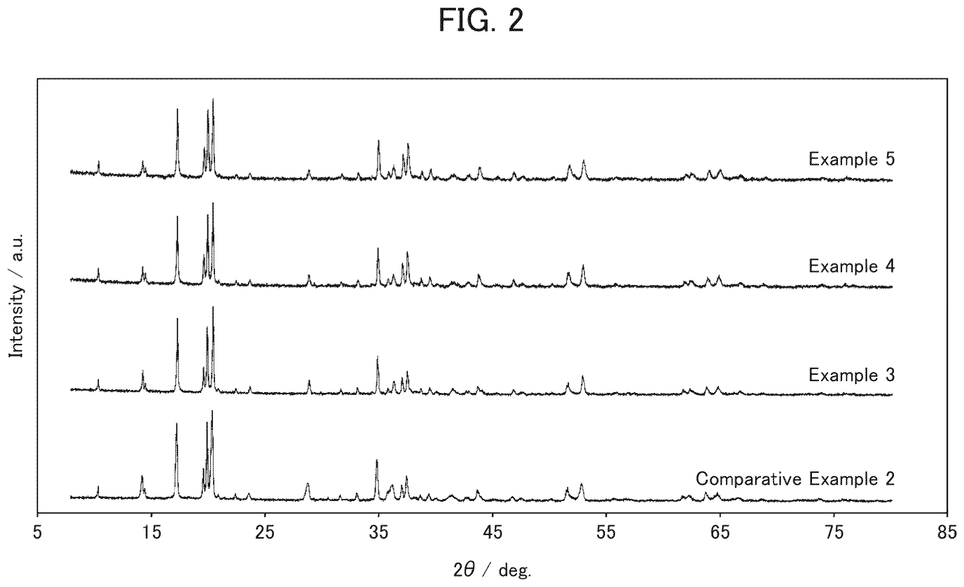

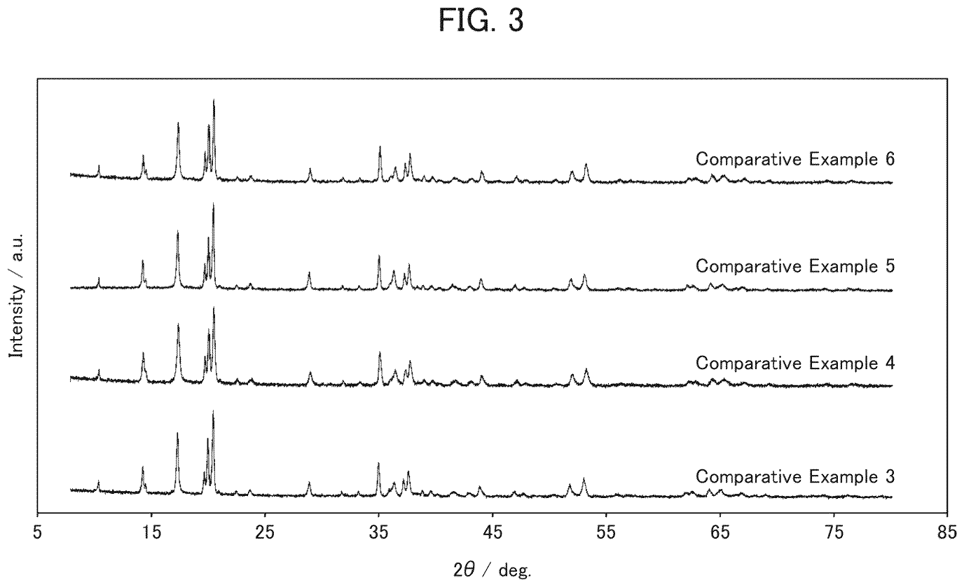

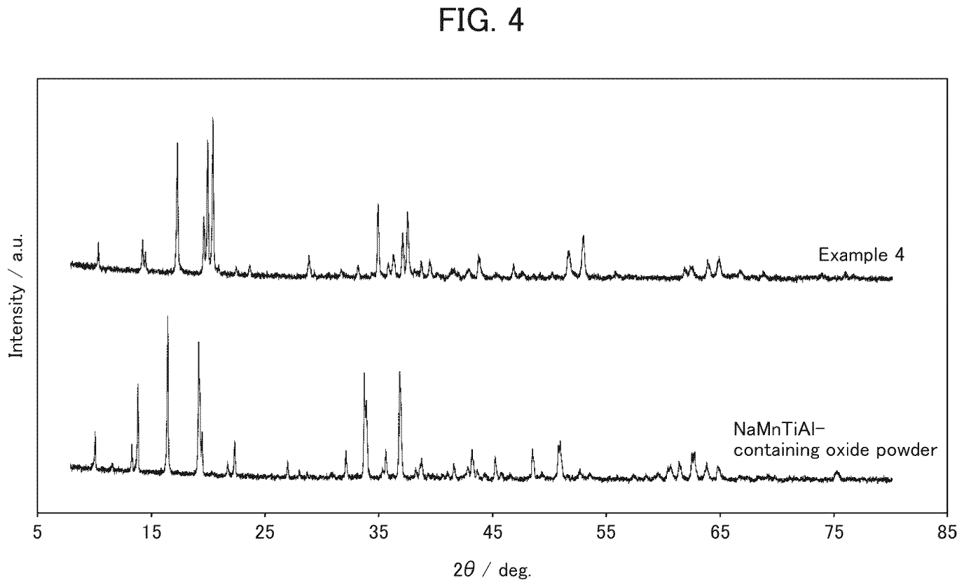

The X-ray diffraction pattern was measured under the following conditions. FIG. 1 shows X-ray diffraction patterns of the LiMnTiAl-containing oxide powders obtained in Examples 1 to 3 and Comparative Example 1, FIG. 2 shows X-ray diffraction patterns of the LiMnTiAl-containing oxide powders obtained in Examples 4 to 6 and Comparative Example 2, and FIG. 3 shows X-ray diffraction patterns of the LiMnTiAl-containing oxide powders obtained in Comparative Examples 3 to 6. FIG. 4 shows an X-ray diffraction pattern of the LiMnTiAl-containing oxide powder obtained in Example 5 and an X-ray diffraction pattern of the NaMnTiAl-containing oxide powder used in the production thereof.

Measurement instrument: smartLab, manufactured by Rigaku
X-Ray Source: Cuka
X-Ray Output: 40 kV, 200 mA

Measurement Conditions: 10.0 s, 0.01 deg step size

From the obtained X-ray diffraction pattern, two diffraction peaks having a diffraction angle of 20 in the range of 19.5 degrees or more and 21.0 degrees or less were extracted. Assuming that the maximum diffraction intensity of the diffraction peak on the low angle side of the two extracted diffraction peaks was A, and the maximum diffraction intensity of the diffraction peak on the high angle side was B, the peak intensity ratio B/A was calculated. The results are shown in Table 2 below.

### (Charge-Discharge Characteristics)

A slurry was prepared by mixing the prepared sample as the positive electrode active material, acetylene black (AB) as a conductive aid, and polyvinylidene fluoride (PVDF) as a binder in a weight ratio of 8:1:1 using NMP (N-methyl-2-pyrrolidone) as a solvent. The obtained slurry was applied to an aluminum foil having a thickness of 20 μm and dried to prepare a positive electrode having a diameter of 14 mm. With respect to the positive electrode, a lithium metal having a thickness of 200 μm and a diameter of 16 mm was used as a counter electrode, and a polyethylene microporous film having a thickness of 20 μm and a diameter of 18 mm was used as a separator. Lithium hexafluorophosphate (LiPF₆) was dissolved in a mixed solvent (volume ratio: 3:4:3) of ethylene carbonate (EC), dimethyl carbonate (DMC), and ethyl methyl carbonate (EMC) to form a 1.2 mol/L solution, whereby a lithium-ion secondary battery (2032 coin cell) was manufactured. The battery was manufactured in accordance with a known cell configuration and assembly method.

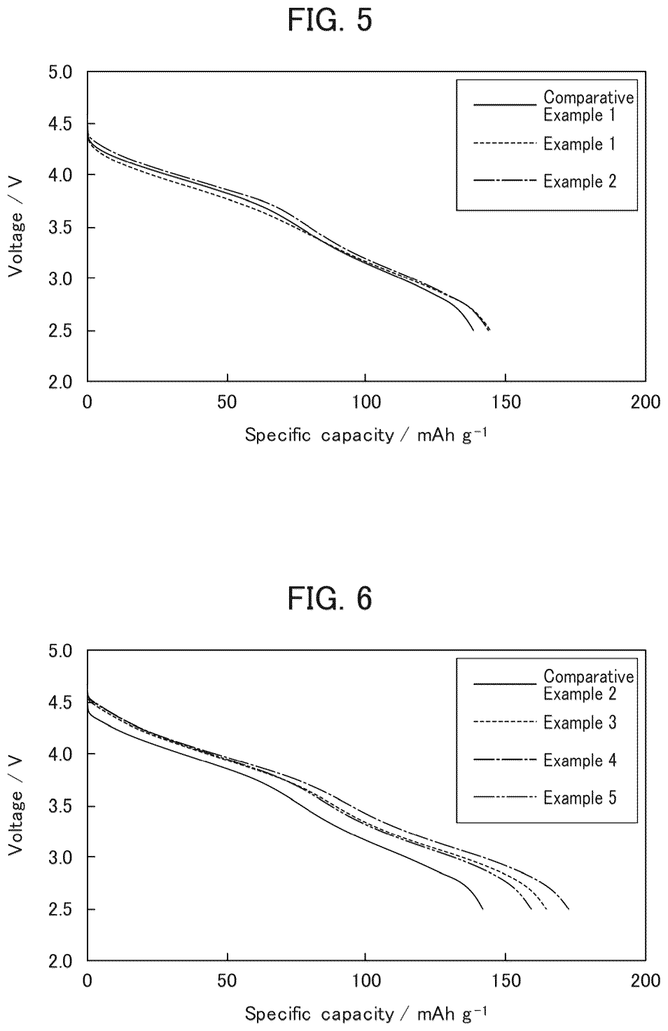

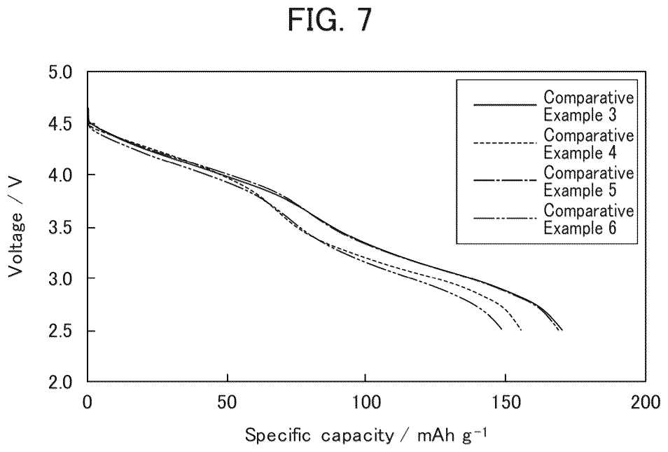

A charge-discharge test was performed using a two-electrode cell. The conditions of the charge and discharge test were such that the current density (per sample) was 10 mA/g, the potential range was 2.5 to 4.8 V, and the charge was performed in constant current-constant voltage charge (until the current density reached 2 mA/g). The charge-discharge test was performed under an environment of 25° C. The initial (first cycle) discharge curves are shown in FIGS. 5 to 7. The charge capacity, discharge capacity, charge/discharge efficiency (first discharge capacity/first charge capacity x 100), average discharge voltage, and energy density (first discharge capacity x average discharge voltage) calculated from the first charge/discharge cycle are shown in Table 3 below.

TABLE 2

| | Li | Na | Mn | Ti | Al | | Peak intensity |
|---|---|---|---|---|---|---|---|
| | (mole) | (mole) | (mole) | (mole) | (mole) | Compositional formula | ratio B/A |
| Example 1 | 0.46 | 0.011 | 0.50 | 0.48 | 0.020 | Li_{0.46}Mn_{0.50}Ti_{0.48}Al_{0.02}O₂ | 1.06 |
| Example 2 | 0.47 | 0.016 | 0.50 | 0.45 | 0.051 | Li_{0.47}Mn_{0.50}Ti_{0.45}Al_{0.05}O₂ | 1.04 |
| Comparative | 0.47 | 0.015 | 0.50 | 0.50 | 0.001 or | Li_{0.47}Mn_{0.50}Ti_{0.50}O₂ | 0.96 |
| Example 1 | | | | | less | | |
| Example 3 | 0.47 | 0.011 | 0.56 | 0.42 | 0.021 | Li_{0.47}Mn_{0.56}Ti_{0.42}Al_{0.02}O₂ | 1.24 |
| Example 4 | 0.47 | 0.011 | 0.56 | 0.39 | 0.050 | Li_{0.47}Mn_{0.56}Ti_{0.39}Al_{0.05}O₂ | 1.13 |
| Example 5 | 0.46 | 0.012 | 0.56 | 0.33 | 0.11 | Li_{0.46}Mn_{0.56}Ti_{0.33}Al_{0.11}O₂ | 1.12 |
| Comparative | 0.48 | 0.021 | 0.55 | 0.45 | 0.001 or | Li_{0.48}Mn_{0.55}Ti_{0.45}O₂ | 1.12 |
| Example 2 | | | | | less | | |
| Comparative | 0.48 | 0.036 | 0.66 | 0.32 | 0.020 | Li_{0.48}Mn_{0.66}Ti_{0.32}Al_{0.02}O₂ | 1.28 |
| Example 3 | | | | | | | |
| Comparative | 0.47 | 0.036 | 0.66 | 0.29 | 0.050 | Li_{0.47}Mn_{0.66}Ti_{0.29}Al_{0.05}O₂ | 1.49 |
| Example 4 | | | | | | | |
| Comparative | 0.45 | 0.036 | 0.66 | 0.23 | 0.11 | Li_{0.45}Mn_{0.66}Ti_{0.23}Al_{0.11}O₂ | 1.33 |
| Example 5 | | | | | | | |
| Comparative | 0.49 | 0.0061 | 0.66 | 0.34 | 0.001 or | Li_{0.49}Mn_{0.67}Ti_{0.33}O₂ | 1.37 |
| Example 6 | | | | | less | | |

TABLE 3

| | | | Charge/ | Average | |
|---|---|---|---|---|---|
| | Charge | Discharge | discharge | discharge | Energy |
| | capacity | capacity | efficiency | voltage | density |
| | (mAh/g) | (mAh/g) | (%) | (V) | (Wh/kg) |
| Example 1 | 105.9 | 144.5 | 136.3 | 3.484 | 503 |
| Example 2 | 104.1 | 143.9 | 138.2 | 3.544 | 510 |
| Comparative | 101.9 | 138.5 | 136.0 | 3.532 | 489 |
| Example 1 | | | | | |
| Example 3 | 111.2 | 165.0 | 148.3 | 3.561 | 587 |
| Example 4 | 117.8 | 172.5 | 146.5 | 3.571 | 616 |
| Example 5 | 111.5 | 159.5 | 143.0 | 3.579 | 571 |
| Comparative | 105.9 | 141.8 | 133.8 | 3.544 | 503 |
| Example 2 | | | | | |
| Comparative | 103.7 | 155.4 | 149.9 | 3.549 | 552 |
| Example 3 | | | | | |
| Comparative | 115.7 | 168.9 | 146.0 | 3.571 | 603 |
| Example 4 | | | | | |
| Comparative | 103.7 | 149.1 | 143.7 | 3.541 | 528 |
| Example 5 | | | | | |
| Comparative | 117.0 | 170.1 | 145.4 | 3.561 | 606 |
| Example 6 | | | | | |

The X-ray diffraction patterns of FIGS. 1 to 3 confirmed that the LiMnTiAl-containing oxide powder obtained in these Examples were in a single phase having a tunnel structure Pbam. The X-ray diffraction pattern of FIG. 4 confirmed that substitution of Na of the NaMnTiAl-containing oxide powder with Li shifted the diffraction peak to the high angle side.

The comparison of Examples 1 and 2 with Comparative Example 1 and the comparison of Examples 3 to 5 with Comparative Example 2 shown in Table 3 confirmed that the LiMnTiAl-containing oxide powder containing Al, which is industrially accessible, is inexpensive, and has a small atomic weight compared with Mn and Ti, within the range of the present invention has an increased discharge capacity compared to the LiMnTi-containing oxide powder which does not contain Al. In addition, from the results of Comparative Examples 3 to 6, it can be seen that with the LiMnTi-containing oxide powder in which the mole amount of Mn is 0.66, the effect of the addition of Al, increase in the discharge capacity, was not obtained. In Table 3, the discharge capacity was higher than the charge capacity in any of Examples 1 to 5 and

### Comparative Examples 1 to 6. This indicates

that the amount of Li moved from the counter electrode to the LiMnTiAl-containing oxide of the positive electrode in the initial discharge is larger than the amount of Li moved from the LiMnTiAl-containing oxide of the positive electrode to the counter electrode in the initial charge.

What is claimed is:

1. A positive electrode active material for a lithium-ion secondary battery represented by the following formula (I):
LiₐMnₓTi_{y}A_{z}O₂ (I)
wherein a satisfies a relationship of 0.40≤a≤0.50, and x, y, and z satisfy relationships of x+y+z=1, 0.48≤x≤ 0.58, 0.31≤y≤0.50, and 0.01≤z≤0.12.

2. The positive electrode active material for a lithium-ion secondary battery according to claim 1, wherein x satisfies a relationship of 0.48≤x≤0.58, y satisfies a relationship of 0.37≤y≤0.50, and z satisfies a relationship of 0.01≤z≤0.06.

3. The positive electrode active material for a lithium-ion secondary battery according to claim 1, having a tunnel structure Pbam.

4. The positive electrode active material for a lithium-ion secondary battery according to claim 3, wherein the positive electrode active material is in a single phase having the tunnel structure Pbam.

5. The positive electrode active material for a lithium-ion secondary battery according to claim 1, wherein an X-ray diffraction pattern measured using CuKα as an X-ray source has two diffraction peaks within a range of a diffraction angle 20 between 19.5 degrees and 21.0 degrees, and of the two diffraction peaks, a ratio of a maximum diffraction intensity of a diffraction peak on a high angle side to a maximum diffraction intensity of a diffraction peak on a low angle side is within a range of 1.00 or more and 1.50 or less.

6. The positive electrode active material for a lithium-ion secondary battery as described in claim 1, wherein a content of Na is 4 mol % or less with respect to a total content of Mn, Ti, and Al.

7. A method for producing the positive electrode active material for a lithium-ion secondary battery according to claim 1, the method comprising substituting at least a part of sodium in the NaMnTiAl-containing oxide having a tunnel structure and represented by the following general formula (II) with lithium:
Na_{b}MnₓTi_{y}A_{z}O₂ (II)
wherein b satisfies a relationship of 0.40≤b≤0.50, and x, y, and z satisfy relationships of x+y+z=1, 0.48≤x≤0.58, 0.31≤y≤0.50, and 0.01≤z≤0.12.

8. A lithium-ion secondary battery comprising a positive electrode material mixture layer comprising the positive electrode active material for a lithium-ion secondary battery according to claim 1.
